(19) United States
(12) Patent Application Publication
(10) Pub. No.: US 2026/0339704 A1
(43) Pub. Date: Oct. 29, 2026

(54) METHOD, APPARATUS, DEVICE AND MEDIUM FOR PROCESSING ACCESS REQUEST

(71) Applicant: Bytedance Technology Ltd., Grand Cayman (KY)

(72) Inventors: Hang WU, Beijing (CN); Hanxiang WEN, Beijing (CN); Hao ZHOU, Beijing (CN)

(21) Appl. No.: 19/653,832

(22) Filed: Apr. 21, 2026

(30) Foreign Application Priority Data
Apr. 21, 2025 (WO) PCT/SG2025/050268

(51) Int. Cl. G06F 9/48

(52) U.S. Cl. CPC G06F 9/4881

(57) ABSTRACT

Methods, apparatuses, devices, and media for processing an access request are provided. In one method, an access request in an application is received, the access request being configured to access an object associated with an application. In response to determining that a type of the object indicates that the object depends on the region associated with the access request, a region associated with the access request is determined. An access address for accessing the object is determined based on the region. The object is provided in the application via the access address. With implementations of this disclosure, it is possible to distinguish whether the access request depends on the region in a more accurate and effective way, and access requests associated with different regions may be processed in different ways. In this way, the application across regional distribution may be managed in an efficient and stable way.

### CROSS-REFERENCE

This application claims priority to International Application No. PCT/SG2025/050268, filed on Apr. 21, 2025, entitled "METHOD, APPARATUS, DEVICE AND MEDIUM FOR PROCESSING ACCESS REQUEST", the entire contents of which are incorporated herein by reference.

### FIELD

Implementations of the present disclosure generally relate to computer technologies, and in particular, to a method, apparatus, device, and computer-readable storage medium for processing an access request in an application.

### BACKGROUND

Applications may provide a variety of functions, for example, various types of data may be accessed in an application. In the field of mobile Internet, data protection is crucial. Applications may include a large amount of reused code logic, especially for mobile end applications that are worldwide or used in other large ranges. Code reuse may result in abnormal data access in different regions, or fail to achieve the expected function. At this point, it is desirable to manage access requests related to different regions in a more accurate and effective way.

### SUMMARY

In a first aspect of the present disclosure, a method for processing an access request is provided. In the method, an access request in an application is received, the access request being configured to access an object associated with an application. In response to determining that a type of the object indicates that the object depends on the region associated with the access request, the region is determined. An access address for accessing the object is determined based on the region. The object is provided in the application via the access address.

In a second aspect of the present disclosure, an apparatus for processing an access request is provided. The apparatus includes: a receiving module configured to receive an access request in an application, the access request being configured to access an object associated with the application; a region determining module configured to determine a region associated with the access request in response to determining that a type of the object indicates that the object depends on the region; an address determining module configured to determine , based on the region, an access address for accessing the object; and a providing module configured to provide the object in the application via the access address.

In a third aspect of the present disclosure, an electronic device is provided. The electronic device includes: at least one processor; and at least one memory coupled to the at least one processor and storing instructions for execution by the at least one processor, the instructions, when executed by the at least one processor, causing the electronic device to perform the method of the first aspect of the present disclosure.

In a fourth aspect of the present disclosure, a computer-readable storage medium having a computer program stored thereon is provided, the computer program, when executed by a processor, causing the processor to implement the method of the first aspect of the present disclosure.

In a fifth aspect of the present disclosure, a computer program product is provided, including a computer program, where the computer program, when executed by a processor, implements the method of the first aspect of the present disclosure.

It should be understood that the content described in this summary section is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various implementations of the present disclosure will become more apparent from the following detailed description taken in conjunction with the accompanying drawings. In the drawings, the same or similar reference numbers refer to the same or similar elements, wherein:

FIG. 1 illustrates a block diagram of an application environment according to one implementation of the present disclosure;

FIG. 2 illustrates a block diagram for processing an access request according to some implementations of the present disclosure;

FIG. 3 illustrates a block diagram of determining an access address by a server according to some implementations of the present disclosure;

FIG. 4A illustrates a block diagram for determining a scheduling configuration according to some implementations of the present disclosure;

FIG. 4B illustrates a block diagram for processing an access request according to some implementations of the present disclosure;

FIG. 4C illustrates a block diagram of an access request for processing a service type according to some implementations of the present disclosure;

FIG. 4D illustrates a block diagram of an access request for processing a resource type according to some implementations of the present disclosure;

FIG. 5A illustrates a block diagram of packaging application code according to some implementations of the present disclosure;

FIG. 5B illustrates a block diagram of processing an access request by a serving gateway according to some implementations of the present disclosure;

FIG. 5C illustrates a block diagram of processing an access request by a content delivery network (CDN) according to some implementations of the present disclosure;

FIG. 6 illustrates a flowchart of a method for processing an access request according to some implementations of the present disclosure;

FIG. 7 illustrates a block diagram of an apparatus for processing an access request according to some implementations of the present disclosure; and

FIG. 8 illustrates a block diagram of a device capable of implementing various implementations of the present disclosure.

### DETAILED DESCRIPTION

Implementations of the present disclosure will be described in more detail below with reference to the accompanying drawings. Although certain implementations of the present disclosure are shown in the accompanying drawings, it should be understood that the present disclosure may be implemented in various forms and should not be interpreted as limited to the implementations set forth herein, on the contrary, these implementations are provided for a more thorough and complete understanding of the present disclosure. It should be understood that the drawings and implementations of the present disclosure are merely for example purposes and are not intended to limit the scope of the present disclosure.

In the description of implementations of the present disclosure, the terms “comprising” and similar terms should be understood as openness, i.e., “comprising but not limited to”. The term “based on” should be understood as “based at least in part on”. The terms “one implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that data involved in the present technical solution (including but not limited to the data itself, obtaining or usage of the data) should follow requirements of the corresponding laws and regulations and related regulations.

It can be understood that, before the technical solutions disclosed in the implementations of the present disclosure are used, types, usage scopes, usage scenarios, and the like of personal information involved in the present disclosure should be informed to users and obtain user authorization in an appropriate way according to the relevant laws and regulations.

For example, in response to receiving an active request of a user, prompt information is sent to the user to explicitly prompt the user that the requested operation will need to obtain and use the personal information of the user. Therefore, the user can autonomously select whether to provide the personal information to software or hardware executing the operation of the technical solution of the present disclosure according to the prompt information.

As an optional but non-limiting implementation, in response to receiving an active request of the user, a way of sending prompt information to the user may be, for example, a pop-up window, and prompt information may be presented in text in the pop-up window. In addition, the pop-up window may further carry a selection control for the user to select “agree” or “disagree” to provide the personal information to the electronic device.

It may be understood that the foregoing notification and obtaining a user authorization process is merely for example, and does not constitute a limitation on implementations of the present disclosure, and other ways of meeting related laws and regulations may also be applied to the implementations of the present disclosure.

The term “in response to” as used herein represents a state in which a corresponding event occurs or a condition is satisfied. It will be understood that an execution timing of a subsequent action performed in response to the event or the condition is not necessarily strongly correlated with the time that the event occurs or the condition is met. For example, in some cases, the subsequent action may be performed immediately when the event occurs or the condition is met; while in some other cases, the subsequent action may be performed after a period of time after the event occurs or the condition is met.

### Example Environment

Implementations of the present disclosure will be described in more detail below with reference to the accompanying drawings. Although certain implementations of the present disclosure are shown in the accompanying drawings, it should be understood that the present disclosure may be implemented in various forms and should not be interpreted as limited to the implementations set forth herein, on the contrary, these implementations are provided for a more thorough and complete understanding of the present disclosure. It should be understood that the drawings and implementations of the present disclosure are merely for example purposes and are not intended to limit the scope of the present disclosure.

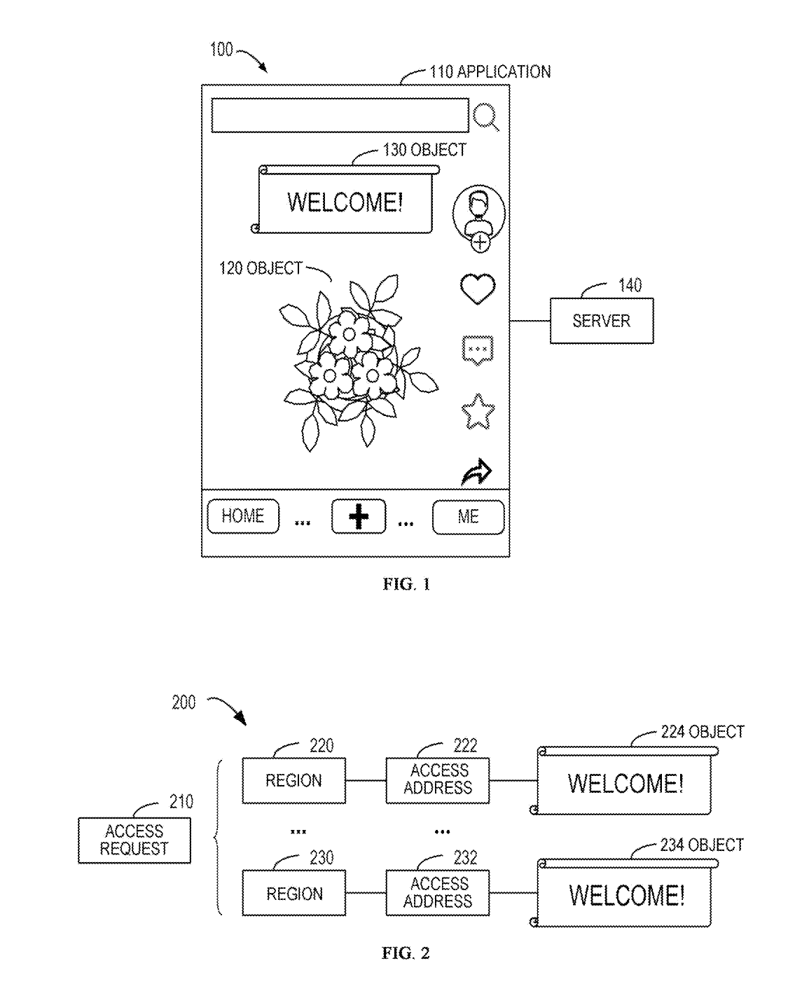

In the field of mobile Internet, data protection is crucial and various types of data may be accessed in an application. See FIG. 1, which describes an application environment of some implementations of the present disclosure, and FIG. 1 illustrates a block diagram 100 of an application environment according to one implementation of the present disclosure. As shown in FIG. 1, an application 110 may be provided and various objects may be accessed and presented in the application 110. For ease of description, FIG. 1 only uses a media application as an example to describe an application environment according to some implementations of the present disclosure. In this case, an object 130 may be, for example, a resource of an image type, and an object 120 may be a resource of a video type, and the like.

The application 110 may be run at a terminal device, and the terminal device may be connected to a server 140. A user may interact with the application 110 in order to access the various objects provided by the server 140. Although FIG. 1 only illustrates a single server, alternatively and/or additionally, the server 140 may have a distributed structure and may include one or more devices. The application 110 may access the server 140 via a network, and the application 110 may be any suitable application with an object presentation function. The application 110 may include, but is not limited to, one or more of : a chat application (also referred to as an instant messaging application), a browser application, a planning type application, a document application, an audio and video conference application, a mail application, a task application, a calendar application, an objectives and key results (OKR) application, and so forth.

It may be understood that although a single application is shown in FIG. 1, in practice, a plurality of applications may be installed on the terminal device. According to some implementations of the present disclosure, the application 110 may include a multifunction collaboration platform, for example, an office collaboration platform (also referred to as an office suite), which can provide integration of a plurality of types of service components, to facilitate people perform activities such as working and communicating. In the multifunctional collaboration platform, the user can launch different service components according to needs to complete corresponding information processing, sharing, communicating and the like.

There may be a communication connection between the terminal device and the server 140. The communication connection may be established in a wired way or a wireless way. The communication connection may include, but is not limited to, a Bluetooth connection, a mobile network connection, a Universal Serial Bus (USB) connection, a Wireless Fidelity (WiFi) connection, and the like, and implementations of the present disclosure are not limited in this aspect. In an implementation of the present disclosure, the terminal device and the server 140 may implement signaling interaction by using the communication connection between the terminal device and the server 140, to supply service to the application 110.

The terminal device may be any type of a mobile terminal, a fixed terminal, or a portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a gaming device, or any combination of the foregoing, including accessories and peripherals of these devices, or any combination thereof. In some implementations, the terminal device may also support any type of interface for a user (such as a “wearable” circuit, etc.).

The server 140 may be an independent physical server, a server cluster composed of a plurality of physical servers, or a distributed system, or may be a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 140 may include, for example, a computing system/server, such as a mainframe, an edge computing node, a computing device in a cloud environment, or the like. It should be understood that structures and functions of various elements in the environment 100 are described for example purposes only and do not imply any limitation to the scope of the present disclosure.

For mobile end applications that worldwide or used in other large ranges, applications may include a large amount of reused code logic, and code reuse may result in abnormal data access in different regions, or fail to achieve the expected function. For example, a welcome image (e.g., object 130) may be displayed in the interface when the application 110 is launched. For a user in region A, the welcome image may include a welcome word displayed in Chinese; for a user in region B, the welcome image may include a welcome word displayed in English, and so on. At this time, when an access request for accessing the welcome image is received, using the code reuse mechanism cannot accurately distinguish an image of which language should be presented in the application. In this case, it is desirable to manage access requests related to different regions in a more accurate and effective way.

### Outline of P rocessing an A ccess R equest

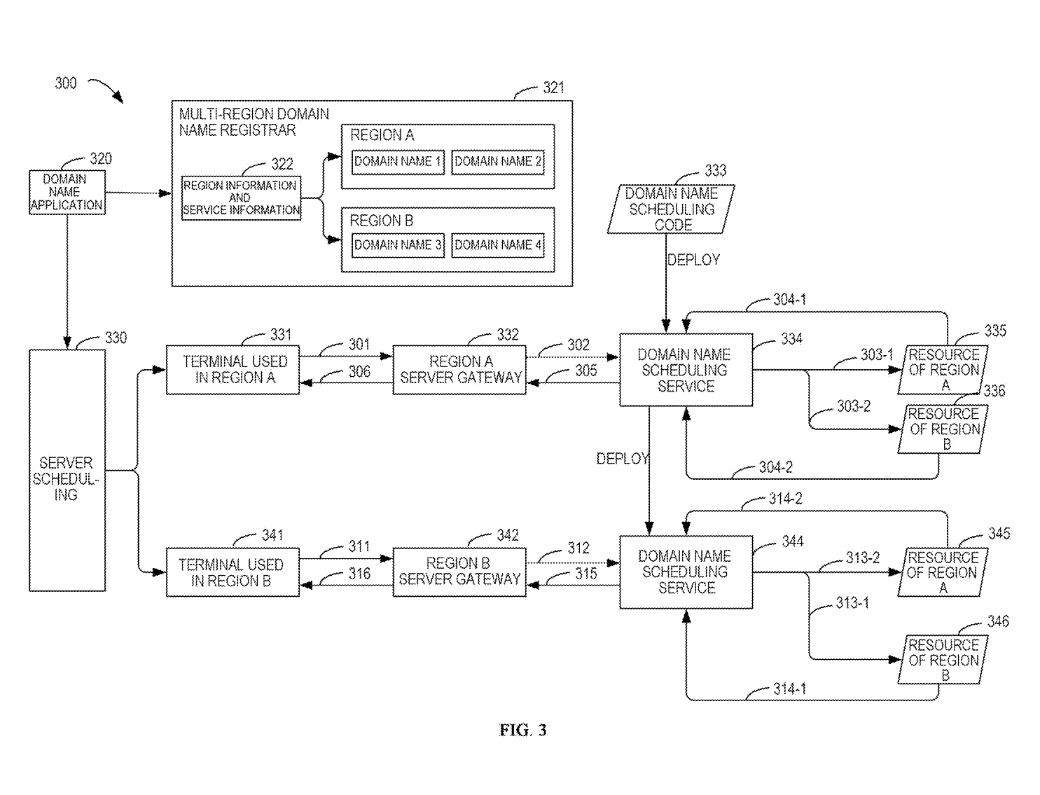

In order to at least partially solve deficiencies in the related art, according to an implementation of the present disclosure, a method for processing an access request is provided. See FIG. 2, which describes an outline according to one implementation of the present disclosure, and FIG. 2 illustrates a block diagram 200 for processing an access request according to some implementations of the present disclosure. As shown in FIG. 2, an access request 210 in the application 110 may be received, and the access request 210 is configured to access an object associated with the application 110. Specifically, the object specified by the access request 210 may be received from the server 140 corresponding to the application 110. It should be understood that, since there may be a plurality of regions, an object corresponding to a particular region is expected to be presented in the application.

For example, there may be a region (e.g., region A) 220, assuming that a predominant language of the user in region A is language A, then an object 224 including a welcome word represented in language A may be presented. At this point, the object 224 may be accessed via an access address 222. For another example, there may be a region (e.g., region B) 230, assuming that the predominant language of the user in region B is language B, then an object 234 including a welcome word represented in language B may be presented. At this point, the object 224 may be accessed via an access address 232.

According to some implementations of the present disclosure, a type of the object specified by the access request 210 may be determined, and the type may represent whether the object depends on a region associated with the access request. In the above welcome word example, the object depends on the region associated with the access request; while in other examples, for example, the object may include background music played during application launch, etc. , then such an object is independent from a region associated with the access request. Further, in response to determining that the type of the object indicates that the object depends on the region associated with the access request, the region associated with the access request may be determined. As shown in FIG. 2, assuming that the region associated with the access request 210 is determined to be the region 220, the access address 222 for accessing the object 224 may be determined based on the region 220. Assuming that the region associated with the access request 210 is determined to be the region 230, the access address 232 for accessing the object 234 may be determined based on the region 230. Then, the object may be provided in the application via the determined access address. At this point, a welcome image may be accurately presented in the application, and the welcome image includes a welcome word that is represented in an expected language.

With implementations of the present disclosure, it is possible to distinguish whether the access request depends on the region in a more accurate and effective way, and access requests associated with different regions may be processed in different ways. In this way, the application across regional distribution may be managed in an efficient and stable way.

### Detailed Procedure of Processing an Access Request

An outline according to some implementations of the present disclosure has been described, more details for managing access requests will be described below. According to some implementations of the present disclosure, an access request in an application may be received, and the access request may be configured to access an object associated with the application. It should be understood that the access request herein may be an access request triggered by a user, for example, the user may interact with a control in the application to submit the access request. Alternatively and/or additionally, the access request may be an access request that is automatically triggered by the application, e.g., an access request to load a welcome image in response to the application being launched, and/or the like. With some implementations of the present disclosure, different types of access requests may be managed in a regional way, so that a data access strategy is consistent with a region.

According to some implementations of the present disclosure, a region associated with the access request (also referred to as a current region) may be determined in various ways. For example, the region associated with the access request may be determined based on at least one of: a registration region of the user in the application, a region selected by the user in the application, a region where the access request is submitted, and a region where the application is downloaded. Specifically, a specific way of determining the region may be specified according to a predetermined rule, for example when the user registers in the application, the rule may specify a region where the terminal device is located as a current region. For another example, the rule may specify a region as the current region where the terminal device is located when the application is downloaded. At this time, the current region will stay unchanged, so it may be easy to manage the application.

Alternatively and/or additionally, the rule may specify a region where the terminal device is located as the current region when the access request is submitted. At this time, the current region will change along with location of the terminal device. As another example, the application may provide the user with a selection function and allow the user to select the current region by himself/herself. At this point, the current region may vary and more flexibility to access different objects may be provided to the user.

According to some implementations of the present disclosure, the type of the object may be specified based on predetermined configuration information. Here, the configuration information may be predefined, e.g., the configuration information may specify that an object 1 in the application is shared for all regions, and an object 2 depends on different regions, and so forth. Specifically, the configuration information may specify: when the user accesses the object 2, if the current region is the region A, an object 2A is provided in the application; if the current region is the region B, an object 2B is provided in the application, and so on.

According to some implementations of the present disclosure, the object 2 may include one or more versions. For example, the object 2A and the object 2B may have the same content, at this point, the object 2A may be stored in a device (e.g., one or more servers) corresponding to the region A, and the object 2B may be stored in a device (e.g., one or more servers) corresponding to the region B. In this way, objects corresponding to different regions may be managed independently, thereby avoiding complex operations of setting a cross-region management of a large number of objects. Alternatively and/or additionally, for example, the object 2A and the object 2B may have different content. In this way, different objects corresponding to different regions may be conveniently isolated, thereby improving data security.

According to some implementations of the present disclosure, an object may include a plurality of types. For example, the object may include a resource provided by a server of the application. For example, an image resource, a text resource, a video resource, and other rich media resources will be presented in a media application, etc. Alternatively and/or additionally, the object may include a service provided by a server of the application. Specifically, the service may be, for example, a translation service provided in the application, for example, based on the current region, a text represented in an original language may be translated into a target language corresponding to the current region. Alternatively and/or additionally, the service may include any other service related to the region, such as a weather forecast service, a traffic information service, or the like. With some implementations of the present disclosure, personalized services may be provided to the user of the application in a more accurate and effective way.

According to some implementations of the present disclosure, in response to determining that the type of the object indicates that the object depends on a region associated with the access request, the region associated with the access request may be determined, and an access address for accessing the object may be determined based on the region. Specifically, assuming that the code reuse mechanism enables applications in region A and region B to both access an object A corresponding to the region A, however an actual demand is that the application in the region A is enabled to access the object A corresponding to the region A and the application in the region B is enabled to access the object B corresponding to the region B. This leads to the access request of the application in the region B which may be abnormal. In this case, the access request of the application in the region B may be updated to access the object B corresponding to the region B. In this way, the access address that best matches the current region may be determined for users in different regions, respectively, thereby meeting user requirements in a more accurate and effective way. Further, situations that objects in each region are accessed without authorization by requests from other regions may be avoided, thereby improving data security.

According to some implementations of the present disclosure, in response to determining that the type of the object indicates that the object is independent from a region associated with the access request, an access address for accessing the object may be determined based on the access request. It should be understood that the type of the object may indicate whether the object depends on the current region, and the access request independent from the current region may be managed in a unified way, thereby simplifying management complexity in the application. Specifically, in a code reuse environment, reuse does not cause object access confusion, and thus it can be ensured that the reused code can achieve an expected purpose.

According to some implementations of the present disclosure, the access address for accessing the object may be determined in different ways and based on the region. Specifically, a server scheduling scheme (determining the access address at a server), a client scheduling scheme (dynamically reading scheduling configuration information and determining the access address at a terminal device), and a client built-in scheme (scheduling configuration information built-in a client and determining the access address) may be provided.

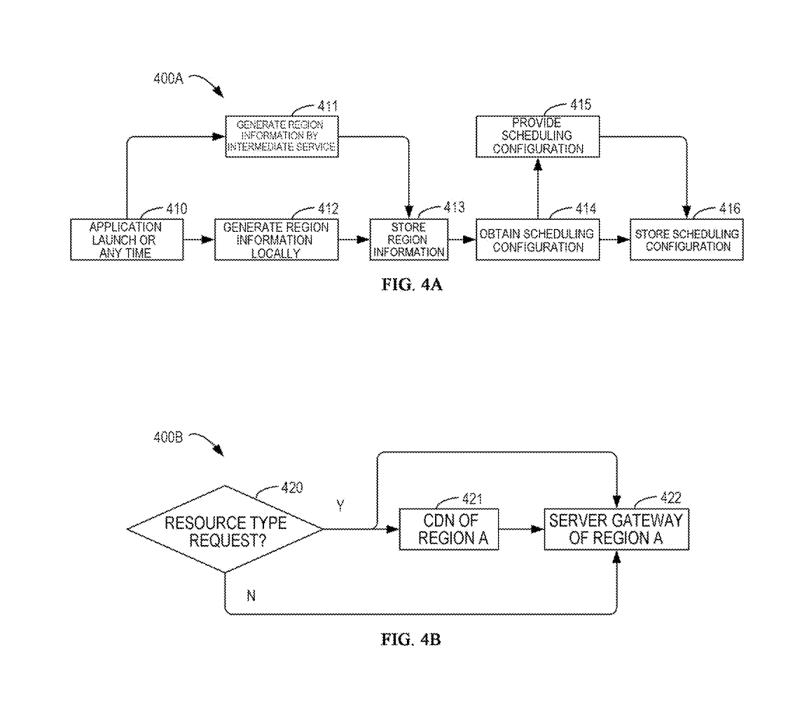

According to some implementations of the present disclosure, during a process of determining the access address for accessing the object based on the region, the server scheduling scheme may be used. Specifically, a domain name corresponding to the region may be determined, and the access address for accessing the object is determined by a scheduling service corresponding to the domain name. Further details are described with reference to FIG. 3, which illustrates a block diagram 300 of determining an access address by a server according to some implementations of the present disclosure. As shown in FIG. 3, at block 320, a domain name application process may be performed. Specifically, the domain name may be applied by invoking a multi-region domain name registrar 321. In this case, region information and service information 322 may be determined.

According to some implementations of the present disclosure, different domain names may be applied for different regions, and domain name resolution may be configured. There needs to be a significant correlation between domain names and region information of different regions (for example, represented by suffixes). For example, the domain name of the region A is xxxx.xxxx.A, and the domain name of the region B is xxxx.xxxx.B. One region may have one or more domain names, for example, the region A may include a plurality of domain names: domain name 1 of the region A and domain name 2 of the region A; the region B may include a plurality of domain names: domain name 3 of the region B and domain name 4 of the region B.

For ease of description, in the following only an example of taking a resource as the object are used to describe the process of processing the access request. At block 330, a server scheduling process may be performed. Specifically, as shown in block 331, a terminal device may be determined to be used in the region A. As indicated by an arrow 301, an access request may be sent to a server gateway of region A 332. As indicated by an arrow 302, the server gateway of the region A 332 may request a resource address from a domain name scheduling server 334. The domain name scheduling service 334 may access a domain name scheduling code 333, thereby deploying a corresponding scheduling service. As shown by an arrow 303-1, the domain name scheduling service 334 may obtain a resource of the region A 335, and as indicated by an arrow 304-1, the domain name scheduling service 334 may return an access address of the resource 335. Alternatively and/or additionally, as indicated by an arrow 303-2, the domain name scheduling service 334 may obtain a resource of the region B 336, and as indicated by an arrow 304-2, the domain name scheduling service 334 may return an access address of the resource 336. Further, as indicated by an arrow 305, the domain name scheduling server 334 may return the access address to a server gateway of the region A 332. The server gateway of the region A 332 may return the access address to the terminal device. Then, in an application in the terminal device, the access address may be used to access the resource corresponding to the region A.

Similarly, the lower part of FIG. 3 illustrates a process corresponding to the region B. Specifically, as shown in block 341,a terminal device may be determined to be used in the region B. As indicated by an arrow 311, an access request may be sent to a server gateway of the region B 342. As indicated by an arrow 312, the server gateway of the region B 342 may request a resource address from a domain name scheduling server 344. The domain name scheduling service 344 may access a domain name scheduling code 333, thereby deploying a corresponding scheduling service. As shown by an arrow 313-1, the domain name scheduling service 344 may obtain a resource of the region B 346, and as indicated by an arrow 314-1, the domain name scheduling service 344 may return an access address of the resource 346. Alternatively and/or additionally, as indicated by an arrow 313-2, the domain name scheduling service 344 may obtain a resource of the region A 345, and as indicated by an arrow 314-2, the domain name scheduling service 344 may return an access address of the resource 345. Further, as indicated by an arrow 315, the domain name scheduling server 344 may return the access address to a server gateway of region B 342. The server gateway of region B 342 may return the access address to the terminal device. Then, in an application in the terminal device, the access address may be used to access the resource corresponding to the region A.

With some implementations of the present disclosure, domain information and domain name information may be configured at a server. For example, relevant domain name information of a portion of regions (or all regions) may be configured, at this point the server will only process access requests from corresponding configured regions. In this way, a powerful processing capability of the server device can be invoked to achieve the ability to isolate the access requests from different regions.

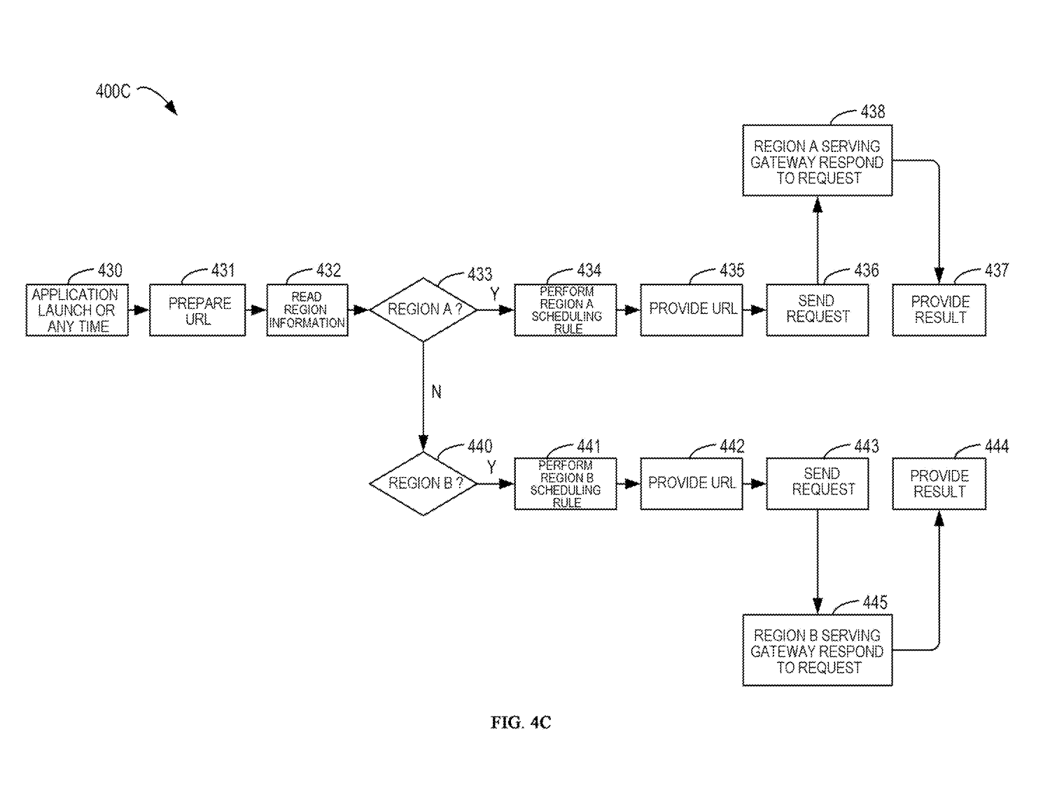

According to some implementations of the present disclosure, a client scheduling scheme may be provided, that is, an access address is determined at the terminal device. Specifically, during a process of determining the access address for accessing the object based on the region, the configuration information may be read at the terminal device running the application, and the access address for accessing the object is generated based on the configuration information and the access request. A process of dynamically processing an access request at a client is described with reference to FIGS. 4A-4D.

FIG. 4A illustrates a block diagram 400A for determining a scheduling configuration according to some implementations of the present disclosure. As shown in FIG. 4A, at block 410, region information may be generated at application launch or at any other time. For example, the region information may be generated at a terminal device locally at block 412; alternatively and/or additionally, the region information may be generated by an intermediate service at block 411. Then, the region information may be stored at block 413. Here, the region information may be, for example, information of the current region (for example, region A, region B, and so on) determined based on the ways described above. At block 414, a scheduling configuration may be obtained. The scheduling configuration may be pre-stored at any computing device. For example, the scheduling configuration may be stored at a server, and the scheduling configuration may be provided to the terminal device periodically or in response to a request from the terminal device. At block 415, the scheduling configuration may be provided; and the scheduling configuration may be stored at block 416.

The scheduling configuration may specify a particular way for determining the access address and may be stored in a variety of ways. For example, the scheduling configuration may be stored with a key-value pair. Assuming that the access request includes an initial uniform resource locator (URL), for example, represented as URL1, a scheduling configuration corresponding to the region A may be represented as <URL1, URL2>, where URL1 represents a key, and URL2 represents a corresponding value. With this scheduling configuration, an original access address URL1 in the access request may be mapped to an actual access address URL2 corresponding to an object of the region A. Alternatively and/or additionally, the scheduling configuration may be stored by using a mapping function. For example, a function URL2 = f(URL1, area) may be specified. URL1 represents the address in the access request, area represents the region, f() represents the mapping function, and URL2 represents the actual access address. It should be understood that the above merely schematically illustrates a simple example of a scheduling configuration, alternatively and/or additionally, the scheduling configuration may include other more complex rules.

FIG. 4B illustrates a block diagram 400B for processing an access request according to some implementations of the present disclosure. As shown in FIG. 4, a type of an object may be determined at block 420. Assuming that the access request is used to obtain an object of the resource type, the operation flow may proceed to block 421 or 422. Specifically, whether a requested resource is included in a content delivery network of the current region A 421 may be determined, and if the requested resource is included in the content delivery network of the current region A 421, the resource is provided by the content delivery network 421; otherwise, the resource is provided by a server gateway of the region A 422. It should be understood that although FIG. 4B only illustrates operations corresponding to the region A, operations corresponding to the region B are also similar.

According to some implementations of the present disclosure, during a process of providing the object in the application via the access address, in response to determining that the content delivery network associated with the application excludes the object specified by the access request, a gateway associated with the region may be determined; and the object is provided via the gateway and based on the access address. With some implementations of the present disclosure, objects expected to be accessed may be obtained in a more accurate and effective way.

Further details are described with reference to FIG. 4C, which illustrates a block diagram 400C of an access request for processing a service type according to some implementations of the present disclosure. As shown in FIG. 4C, a service may be requested by a terminal device. At block 430, the process shown in FIG. 4C may be invoked at application launch or at any other time. At block 431, a URL (e.g., URL1) for accessing the requested object may be prepared. At block 432, region information such as the region A or the region B may be read. At block 433, if the current region is determined to be the region A, then at block 434, a scheduling rule of the region A is performed and the generated URL is provided at block 435. At block 436, a request may be sent (i.e., requesting obtaining of the service at the URL). At block 438, the serving gateway of the region A may respond to the request and provide a result (i.e., return the requested object corresponding to the region A, e.g., the service specified by the access request) at block 437.

Similarly, at block 440, if the current region is determined to be the region B, then at block 441, a scheduling rule of the region B is performed and the generated URL is provided at block 442. At block 443, a request may be sent (i.e., requesting obtaining of the service at the URL). At block 445, the serving gateway of the region B may respond to the request and provide a result (i.e., return the requested object corresponding to the region B, e.g., the service specified by the access request) at block 444.

According to some implementations of the present disclosure, during a process of providing the object in the application via the access address, the object may be provided by a content delivery network in response to determining that the content delivery network associated with the application includes the object specified by the access request. With some implementations of the present disclosure, caching capability of the content delivery network may be fully utilized to provide the object to the terminal device at a faster speed.

Further details are described with reference to FIG. 4D, which illustrates a block diagram 400D of an access request for processing a resource type according to some implementations of the present disclosure. As shown in FIG. 4D, a resource may be requested by a terminal device. At block 450, the process shown in FIG. 4D may be invoked at application launch or at any other time. At block 451, region information such as the region A or the region B may be read. At block 452, if the current region is determined to be the region A, then at block 453, a scheduling rule of the region A is performed and the generated URL is provided at block 454. At block 455, a request may be sent (i.e., requesting obtaining of the resource at the URL). At block 457, CDN of the region A may respond to the request and provide a result (i.e., return the requested object corresponding to the region A, e.g., the resource specified by the access request) at block 456.

Similarly, at block 460, if the current region is determined to be the region B, then at block 461, a scheduling rule of the region B is performed and the generated URL is provided at block 462. At block 463, a request may be sent (i.e., requesting obtaining of the resource at the URL). At block 465, CDN of the region B may respond to the request and provide a result (i.e., return the requested object corresponding to the region B, e.g., the resource specified by the access request) at block 464.

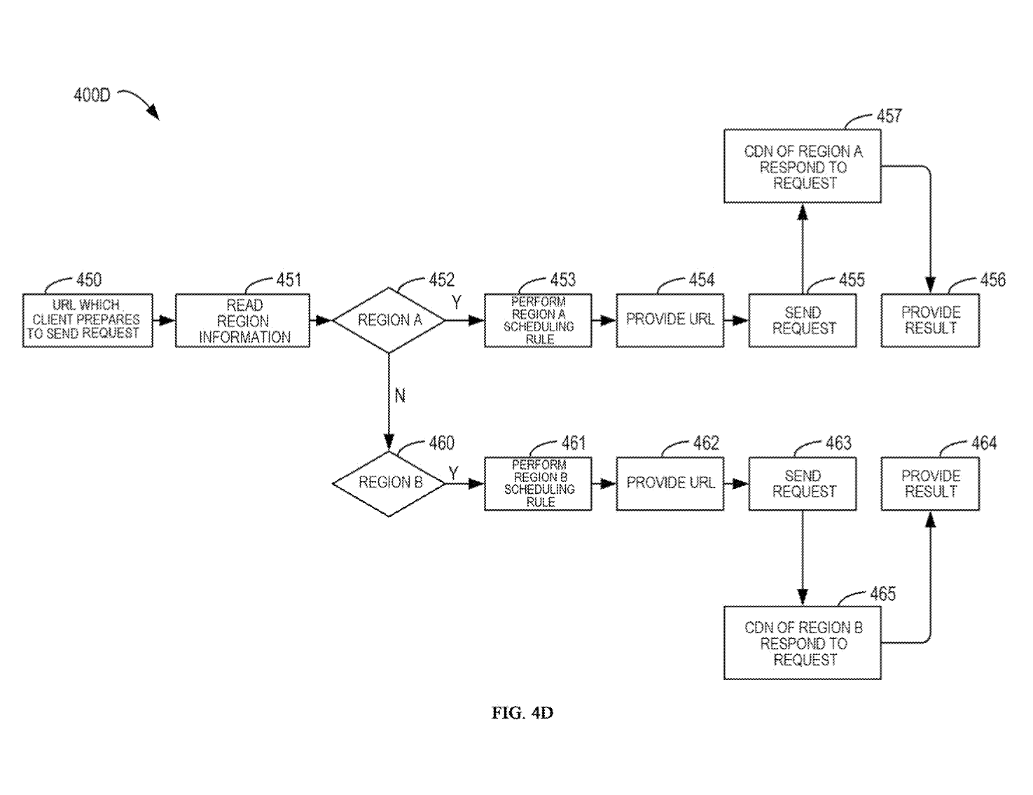

According to some implementations of the present disclosure, a client built-in scheme may be provided. In other words, different application codes may be respectively packaged for different regions, so that corresponding access addresses may be determined by reading configuration information predetermined in the applications. Further details are described with reference to FIGS. 5A-5C.

FIG. 5A illustrates a block diagram 500A of packaging application code according to some implementations of the present disclosure. As shown in FIG. 5A, an application code 512 may be packaged at a stage of compilation construction 510. As shown in block 514, domain name information of the region A may be built in the code. Alternatively and/or additionally, domain name information of the region B may be built in another packaging code. FIG. 5B illustrates a block diagram 500B of processing an access request by a serving gateway according to some implementations of the present disclosure. In 5B, at runtime 520, as shown at block 521, a URL may be prepared at a terminal device. At block 522, a built-in service domain name and a request path may be concatenated. For example, a domain name address may be added at the front end of the request path to generate an access address for accessing an object corresponding to the current region. At block 523, a request may be sent. At block 525, a serving gateway of the region A may respond to the request and provide a result of the access at block 524. Although FIG. 5B illustrates an operational process corresponding to the region A, an operational process corresponding to the region B may be similar.

FIG. 5C illustrates a block diagram 500C of processing an access request by a content delivery network according to some implementations of the present disclosure. In 5C, at runtime 530, as shown at block 531, a URL may be prepared at the terminal device. At block 532, the built-in service domain name and the request path may be concatenated. For example, a domain name address may be added at the front end of the request path to generate an access address for accessing an object corresponding to the current region. At block 533, a request may be sent. At block 535, a CDN of the region A may respond to the request and provide a result of the access at block 534. Although FIG. 5C illustrates an operational process corresponding to the region A, an operational process corresponding to the region B may be similar.

It should be understood that although specific processes of the server scheduling scheme, the client scheduling scheme, and the client built-in scheme are respectively described above, any two scheduling schemes described above may be combined. Alternatively and/or additionally, the three scheduling schemes described above may be combined. Specifically, the server scheduling scheme and the client scheduling scheme may be combined. For example, different scheduling schemes may be set for different types of objects. In response to receiving an access request for accessing an object, the object is first determined either a resource or a service, the server scheduling scheme may be used to process a service related access request, and the client scheduling scheme may be used to process a resource related access request.

According to some implementations of the present disclosure, a scheduling scheme may be selected based on complexity of a scheduling rule. It is assumed that there is a plurality of resource types, for example, including an image resource, a text resource, a video resource, an audio resource, etc., and respectively setting a scheduling rule for each resource may result in a huge workload. In this case, the server scheduling scheme may be used, for example, a respective domain name may be set for each region, and a corresponding access address may be quickly determined in a domain name binding way, thereby improving resource access speed.

According to some implementations of the present disclosure, a conflict resolution strategy may be set for a plurality of scheduling schemes. For example, a range of each scheduling scheme itself may be set. Assuming that there is a region A, a region B, a region C and a region D, the server scheduling scheme may include corresponding domain names of the region A and the region B, at this time, the server scheduling scheme may be performed for the region A and the region B, and the client scheduling scheme or the client built-in scheme may be performed for the region C and the region D.

With implementations of the present disclosure, it is possible to distinguish whether the access request depends on the region in a more accurate and effective way, and access requests associated with different regions may be processed in different ways. In this way, the application across regional distribution may be managed in an efficient and stable way.

### Example Processes

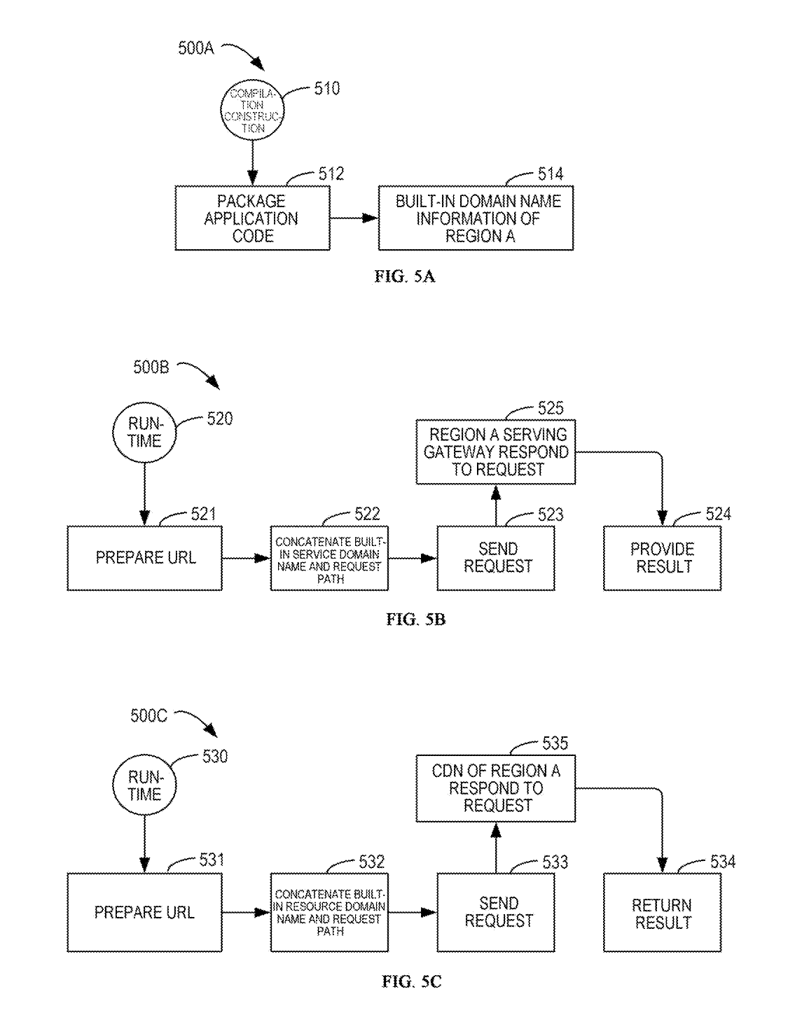

FIG. 6 illustrates a flowchart of a method 600 for processing an access request according to some implementations of the present disclosure. At block 610, an access request in an application is received, the access request being configured to access an object associated with the application. At block 620, in response to determining that a type of the object indicates that the object depends on a region associated with the access request, the region is determined. At block 630, an access address for accessing the object is determined based on the region. At block 640, the object is provided in the application via the access address.

According to some implementations of the present disclosure, determining, based on the region, the access address for accessing the object includes: determining a domain name corresponding to the region; and determining, by a scheduling service corresponding to the domain name, the access address for accessing the object.

According to some implementations of the present disclosure, determining, based on the region, the access address for accessing the object includes: reading configuration information at a terminal device running the application; and generating, based on the configuration information and the access request, the access address for accessing the object.

According to some implementations of the present disclosure, providing the object in the application via the access address includes: providing, in response to determining that a content delivery network associated with the application includes the object specified by the access request, the object by the content delivery network.

According to some implementations of the present disclosure, providing the object in the application via the access address includes: determining a gateway associated with the region in response to determining that a content delivery network associated with the application excludes the object specified by the access request; and providing the object via the gateway and based on the access address.

According to some implementations of the present disclosure, determining the region associated with the access request includes determining the region based on at least one of: a registration region of a user in the application; a region selected by a user in the application; a region where the access request is submitted; or a region where the application is downloaded.

According to some implementations of the present disclosure, the type of the object is specified based on predetermined configuration information.

According to some implementations of the present disclosure, the method further includes: determining, in response to determining that a type of the object indicates that the object is independent from a region associated with the access request, an access address for accessing the object, based on the access request.

According to some implementations of the present disclosure, the object includes at least one of: a service provided by a server of the application or a resource provided by a server of the application.

### Example Apparatus and Apparatus

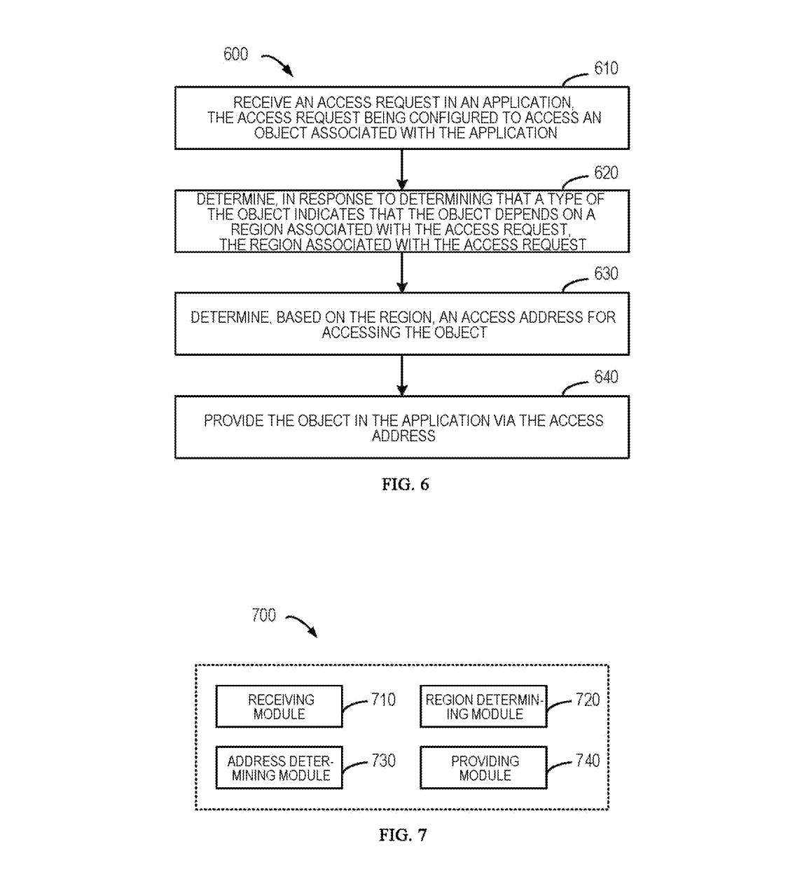

FIG. 7 illustrates a block diagram of an apparatus 700 for processing an access request according to some implementations of the present disclosure. The apparatus 700 includes: a receiving module 710 configured to receive an access request in an application, the access request being configured to access an object associated with the application; a region determining module 720 configured to determine a region associated with the access request in response to determining that a type of the object indicates that the object depends on the region; an address determining module 730 configured to determine, based on the region, an access address for accessing the object; and a providing module 740 configured to provide the object in the application via the access address.

According to some implementations of the present disclosure, the address determining module is further configured to: determine a domain name corresponding to the region; and determine, by a scheduling service corresponding to the domain name, the access address for accessing the object.

According to some implementations of the present disclosure, the address determining module is further configured to: read configuration information at a terminal device running the application; and generate, based on the configuration information and the access request, the access address for accessing the object.

According to some implementations of the present disclosure, the providing module is further configured to: provide, in response to determining that a content delivery network associated with the application includes the object specified by the access request, the object by the content delivery network.

According to some implementations of the present disclosure, the providing module is further configured to: determine a gateway associated with the region in response to determining that a content delivery network associated with the application excludes the object specified by the access request; and provide the object via the gateway and based on the access address.

According to some implementations of the present disclosure, the region determining module is further configured to determine the region based on at least one of the following: a registration region of a user in the application; a region selected by a user in the application; a region where the access request is submitted; or a region where the application is downloaded.

According to some implementations of the present disclosure, the type of the object is specified based on predetermined configuration information.

According to some implementations of the present disclosure, the address determining module is further configured to: determine, in response to determining that a type of the object indicates that the object is independent from a region associated with the access request, an access address for accessing the object, based on the access request.

According to some implementations of the present disclosure, the object includes at least one of: a service provided by a server of the application or a resource provided by a server of the application.

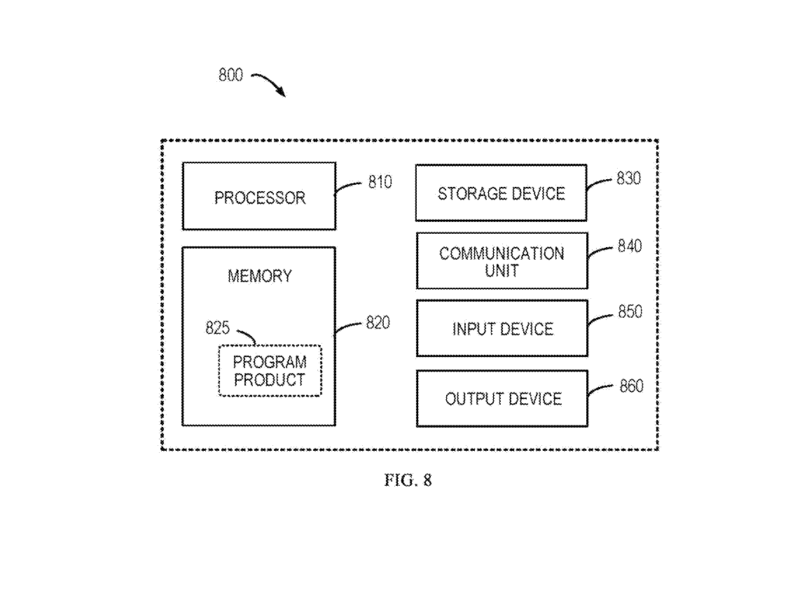

FIG. 8 illustrates a block diagram of a device 800 capable of implementing various implementations of the present disclosure. It should be understood that the computing device 800 shown in FIG. 8 is merely for example and should not constitute any limitation on the functionality and scope of the implementations described herein. The computing device 800 shown in FIG. 8 may be configured to implement the method described above.

As shown in FIG. 8, the computing device 800 is in a form of a general-purpose computing device. Components of the computing device 800 may include, but are not limited to, one or more processors 810, a memory 820, a storage device 830, one or more communication units 840, one or more input devices 850, and one or more output devices 860. The processor 810 may be an actual or virtual processor and capable of performing various processes according to programs stored in the memory 820. In a multiprocessor system, a plurality of processors perform computer-executable instructions in parallel to improve parallel processing capabilities of the computing device 800.

The computing device 800 typically includes a plurality of computer storage media. Such media may be any available media accessible to the computing device 800, including, but not limited to, volatile and non-volatile media, removable and non-removable media. The memory 820 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 830 may be a removable or non-removable medium and may include a machine-readable medium, such as a flash drive, magnetic disk, or any other medium, which may be capable of storing information and/or data (e.g., training data for training) and may be accessed within the computing device 800.

The computing device 800 may further include additional removable/non-removable, volatile/non-volatile storage media. Although not shown in FIG. 8, a disk drive for reading or writing from a removable, non-volatile magnetic disk (e.g., a “floppy disk”) and an optical disk drive for reading or writing from a removable, non-volatile optical disk may be provided. In these cases, each drive may be connected to a bus (not shown) by one or more data media interfaces. The memory 820 may include a computer program product 825 having one or more program modules configured to perform various methods or acts of various implementations of the present disclosure.

The communication unit 840 is configured to communicate with other computing devices over a communication medium. Additionally, the functionality of components of the computing device 800 may be implemented in a single computing cluster or a plurality of computing machines capable of communicating over a communication connection. Thus, the computing device 800 may operate in a networked environment using logical connections with one or more other servers, network personal computers (PCs), or another network node.

The input device 850 may be one or more input devices, such as a mouse, a keyboard, a trackball, or the like. The output device 860 may be one or more output devices, such as a display, a speaker, a printer, or the like. The computing device 800 may also communicate with one or more external devices (not shown) through the communication unit 840 as needed, the external devices such as storage devices, display devices, etc. , communicate with one or more devices that enable a user to interact with the computing device 800, or communicate with any device (e.g., a network card, a modem, etc. ) that enables the computing device 800 to communicate with one or more other computing devices. Such communication may be performed via an input/output (I/O) interface (not shown).

According to an implementation of the present disclosure, a computer-readable storage medium having computer-executable instructions stored thereon is provided, where the computer-executable instructions are executed by a processor to implement the method described above. According to the implementation of the present disclosure, a computer program product is further provided, the computer program product being tangibly stored on a non-transitory computer-readable medium and including computer-executable instructions, and the computer-executable instructions being executed by a processor to implement the method described above. According to the implementation of the present disclosure, a computer program product having a computer program stored thereon is provided, when the program is executed by a processor, implementing the foregoing method.

Aspects of the present disclosure are described herein with reference to flowcharts and/or block diagrams of methods, apparatuses, devices, and computer program products implemented in accordance with the present disclosure. It should be understood that each block of the flowcharts and/or block diagrams, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce apparatuses to implement the functions/acts specified in the flowcharts and/or block diagrams. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowcharts and/or block diagrams.

The computer-readable program instructions may be loaded onto a computer, other programmable data processing apparatuses, or other devices, such that a series of operational steps are performed on a computer, other programmable data processing apparatuses, or other devices to produce a computer-implemented process, thereby enabling the instructions executed on a computer, other programmable data processing apparatuses, or other devices to implement the functions/acts specified in the flowchart and/or block diagram block or blocks.

The flowcharts and block diagrams in the drawings show architecture, functionality, and operation of possible implementations of systems, methods, and computer program products according to various implementations of the present disclosure. In this regard, each block in the flowcharts or block diagrams may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in a reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or acts, or may be implemented in a combination of dedicated hardware and computer instructions.

Various implementations of the present disclosure have been described above, and the above descriptions are, for example, not exhaustive, and are not limited to the implementations disclosed. Many modifications and variations without departing from the scope and spirit of the various implementations illustrated will be apparent to those of ordinary skill in the art. Selection of the terms used herein is intended to best explain principles of the implementations, practical applications, or improvements to techniques in the marketplace, or to enable others of ordinary skill in the art to understand the various implementations disclosed herein.

What is claimed is:

1. A method for processing an access request, comprising:
receiving an access request in an application, the access request being configured to access an object associated with the application;
determining a region associated with the access request in response to determining that a type of the object indicates that the object depends on the region;
determining, based on the region, an access address for accessing the object; and
providing the object in the application via the access address.

2. The method of claim 1, wherein determining, based on the region, the access address for accessing the object comprises:
determining a domain name corresponding to the region; and
determining, by a scheduling service corresponding to the domain name, the access address for accessing the object.

3. The method of claim 1, wherein determining, based on the region, the access address for accessing the object comprises:
reading configuration information at a terminal device running the application; and
generating, based on the configuration information and the access request, the access address for accessing the object.

4. The method of claim 1, wherein providing the object in the application via the access address comprises: providing, in response to determining that a content delivery network associated with the application comprises the object specified by the access request, the object by the content delivery network.

5. The method of claim 1, wherein providing the object in the application via the access address comprises:
determining a gateway associated with the region in response to determining that a content delivery network associated with the application excludes the object specified by the access request; and
providing the object via the gateway and based on the access address.

6. The method of claim 1, wherein determining the region associated with the access request comprises determining the region based on at least one of:
a registration region of a user in the application;
a region selected by a user in the application;
a region where the access request is submitted; or
a region where the application is downloaded.

7. The method of claim 1, wherein the type of the object is specified based on predetermined configuration information.

8. The method of claim 1, further comprising: determining, in response to determining that a type of the object indicates that the object is independent from a region associated with the access request, an access address for accessing the object, based on the access request.

9. The method of claim 1, wherein the object comprises at least one of: a service provided by a server of the application or a resource provided by a server of the application.

10. An electronic device, comprising:
at least one processor; and
at least one memory coupled to the at least one processor and storing instructions for execution by the at least one processor, the instructions, when executed by the at least one processor, causing the electronic device to perform acts comprising:
receiving an access request in an application, the access request being configured to access an object associated with the application;
determining a region associated with the access request in response to determining that a type of the object indicates that the object depends on the region;
determining, based on the region, an access address for accessing the object; and
providing the object in the application via the access address.

11. The electronic device of claim 10, wherein determining, based on the region, the access address for accessing the object comprises:
determining a domain name corresponding to the region; and
determining, by a scheduling service corresponding to the domain name, the access address for accessing the object.

12. The electronic device of claim 10, wherein determining, based on the region, the access address for accessing the object comprises:
reading configuration information at a terminal device running the application; and
generating, based on the configuration information and the access request, the access address for accessing the object.

13. The electronic device of claim 10, wherein providing the object in the application via the access address comprises: providing, in response to determining that a content delivery network associated with the application comprises the object specified by the access request, the object by the content delivery network.

14. The electronic device of claim 10, wherein providing the object in the application via the access address comprises:
determining a gateway associated with the region in response to determining that a content delivery network associated with the application excludes the object specified by the access request; and
providing the object via the gateway and based on the access address.

15. The electronic device of claim 10, wherein determining the region associated with the access request comprises determining the region based on at least one of:
a registration region of a user in the application;
a region selected by a user in the application;
a region where the access request is submitted; or
a region where the application is downloaded.

16. The electronic device of claim 10, wherein the type of the object is specified based on predetermined configuration information.

17. The electronic device of claim 10, further comprising: determining, in response to determining that a type of the object indicates that the object is independent from a region associated with the access request, an access address for accessing the object, based on the access request.

18. The electronic device of claim 10, wherein the object comprises at least one of: a service provided by a server of the application or a resource provided by a server of the application.

19. A non-tansitory computer-readable storage medium having computer instructions stored thereon, the computer instructions, when executed by a processor, causing the processor to perform acts comprising:
receiving an access request in an application, the access request being configured to access an object associated with the application;
determining a region associated with the access request in response to determining that a type of the object indicates that the object depends on the region;
determining, based on the region, an access address for accessing the object; and
providing the object in the application via the access address.

20. The non-tansitory computer-readable storage medium of claim 19, wherein determining, based on the region, the access address for accessing the object comprises:
determining a domain name corresponding to the region; and
determining, by a scheduling service corresponding to the domain name, the access address for accessing the object.
